(19) United States
(12) Patent Application Publication
(10) Pub. No.: US 2005/0086109 A1
(43) Pub. Date: Apr. 21, 2005

(54) Methods and apparatus for posting messages on documents delivered over a computer network

(76) Inventors: Jeffrey A. McFadden, Hillsborough, CA (US); David L. Goulden, Redwood City, CA (US); Eugene A. Veteska, San Jose, CA (US); Anthony G. Martin, Los Altos, CA (US); Roger J. Petersen, Palo Alto, CA (US)

Correspondence Address: OKAMOTO & BENEDICTO, LLP, P.O. BOX 641330, SAN JOSE, CA, 95164, US

(21) Appl. No.: 10/951,669

(22) Filed: Sep. 28, 2004

Related U.S. Application Data
(60) Provisional application No. 60/512,605, filed on Oct. 17, 2003.
(60) Provisional application No. 60/574,455, filed on May 26, 2004.

(51) Int. Cl. G06F 17/60; G06F 15/173

(52) U.S. Cl. 705/14; 709/224

(57) ABSTRACT

In one embodiment, a message posted on a document delivered over a computer network is based on consumer behavioral information. The behavioral information may be obtained by monitoring the consumer's activities across several locations in the computer network. The message may be an advertisement, while the document may be a web page. The advertisement may be selected based on the consumer's browsing activities across several unrelated web sites on the Internet.

### REFERENCE TO RELATED APPLICATIONS

This application claims the benefit of U.S. Provisional Application No. 60/512,605, filed on Oct. 17, 2003 and U.S. Provisional Application No. 60/574,455 filed on May 26, 2004, both of which are incorporated herein by reference in their entirety.

### BACKGROUND OF THE INVENTION

1. Field of the Invention

The present invention relates generally to computer systems, and more particularly to methods and apparatus for posting messages on documents delivered over a computer network.

2. Description of the Background Art

Large computer networks, such as the Internet, allow for relatively widespread and fast dissemination of information. On the Internet, for example, websites providing online services or information on various topics are readily accessible. A consumer having a computer and a web browser may navigate to one or more websites to access news, maps, computer programs, video, music, products, e-mail, and so on.

Websites typically run on one or more server computers that store downloadable documents referred to as “web pages.” As is well known, a web page may comprise textual and graphical data, as well as computer-readable program code for pulling-in data from other sources. For example, a web page may have textual and graphical data about a news event and a “slot” where an advertisement may be displayed. The slot functions as a place holder for advertisements to be displayed on the web page. The uniform resource locator (URL) of the advertisement may be “inserted” in the slot such that when the consumer receives the web page for viewing in her computer, the advertisement is pulled from a content server and posted on the web page.

Advertisements have the same role on the Internet as in radio and television. Generally speaking, advertisements generate revenue that allows an online publisher (e.g., operator of a website) to provide free or low cost access to information or service. For example, advertisements allow some online publishers to provide free e-mail service. When a consumer logs on to receive her e-mail, she receives a web page with e-mail contents along with one or more advertisements.

Typical advertisements posted on web pages are ineffective in that they are irrelevant to most consumers. In the free e-mail example, consumers checking their e-mails might get an advertisement for a classmate search service even if they are not specifically looking for former classmates. Publishers may scan textual information on requested web pages to determine the most relevant advertisement to display. However, this technique is not reliable because of the difficulty of scanning and analyzing hundreds of words that are on a typical web page. These result in the posting of irrelevant advertisements that are ignored by most consumers.

### SUMMARY

In one embodiment, a message posted on a document delivered over a computer network is based on consumer behavioral information. The behavioral information may be obtained by monitoring the consumer's activities across several locations in the computer network. The message may be an advertisement, while the document may be a web page. The advertisement may be selected based on the consumer's browsing activities across several unrelated web sites on the Internet.

These and other features of the present invention will be readily apparent to persons of ordinary skill in the art upon reading the entirety of this disclosure, which includes the accompanying drawings and claims.

### DESCRIPTION OF THE DRAWINGS

FIGS. 1, 2, 3A, 3B, and 4 show schematic diagrams illustrating various techniques for posting messages on documents, in accordance with embodiments of the present invention.

The use of the same reference label in different drawings indicates the same or like components

### DETAILED DESCRIPTION

In the present disclosure, numerous specific details are provided such as examples of apparatus, components, and methods, to provide a thorough understanding of embodiments of the invention. Persons of ordinary skill in the art will recognize, however, that the invention can be practiced without one or more of the specific details. In other instances, well-known details are not shown or described to avoid obscuring aspects of the invention.

Embodiments of the present invention are described herein in the context of advertising delivery over the Internet. It should be understood, however, that embodiments of the present invention may be generally employed to post messages in documents delivered over other types of computer networks.

Embodiments of the present invention employ a message delivery program in communication with a message server. Message delivery programs and message servers are also disclosed in the following commonly-assigned disclosures, which are incorporated herein by reference in their entirety: U.S. application Ser. No. 10/152,204, filed on May 21, 2002, and U.S. application Ser. No. 10/289,123, filed on Nov. 5, 2002.

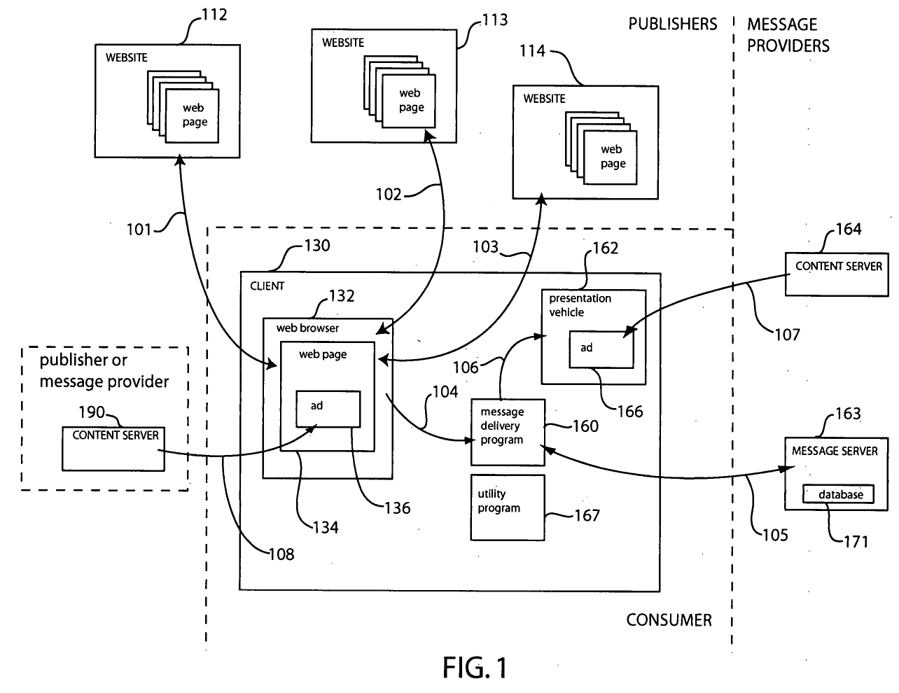

FIG. 1 schematically illustrates a technique for posting messages on documents in accordance with an embodiment of the present invention. In the example of FIG. 1, websites 112-114 are operated by online publishers, such as those that provide news, search engines, forums, audio and video streaming, e-mail service, and so on over the Internet. A website may be hosted in one or more server computers. A website may comprise one or more web pages accessible over the Internet.

A client computer 130 may comprise a computer operated by a consumer navigating on the Internet. A client computer 130 may comprise a personal computer running the Microsoft Windows™ operating system, for example. Depending on the application, a client computer 130 may also be a portable or hand-held device, such as a laptop computer, a personal digital assistant, a digital mobile telephone, and so on. A consumer may employ a web browser 132 to access web pages on websites on the Internet. Web browser 132 may be a commercially available web browser, such as the Microsoft Internet Explorer™ web browser, for example. Web browser 132 allows client computer 130 to receive one or more web pages 134 from among accessible websites on the Internet. A web page 134 may include an advertisement 136 posted by a server associated with a publisher or a message provider.

In the present disclosure, online service providers that are not associated with the operators of websites 112-114 are arbitrarily referred to as “message providers.” For example, a message provider may be a software developer that provides free or reduced-cost software to consumers. As another example, a message provider may provide free or reduced-cost access to websites operated by online publishers or other message providers. As a further example, a message provider may provide online services, such as e-mailed news service, streaming audio/video, voice-over-IP service, and so on.

A message provider may provide software or online services for free or at a reduced cost in return for the right to deliver messages to the consumer. The messages may be paid messages, such as advertisements for products (i.e., goods and services). The messages may also be non-product related, such as political and election campaign messages. In the example of FIG. 1, the consumer receives advertisements in client computer 130 in return for a free utility program 167. Utility program 167 may be an e-wallet or an appointment calendar, for example. A message delivery program 160 may be provided to client computer 130 along with utility program 167. Message delivery program 160 may initiate the displaying of a presentation vehicle 162 to display an advertisement 166. Presentation vehicle 162 may be a browser window or custom window. For example, presentation vehicle 162 may be a pop-up or pop-under window.

In one embodiment, message delivery program 160 is a client-side program that monitors the browsing activity of the consumer across several websites, and reports its observations to message server 163. It is to be noted that the mechanics of monitoring a consumer's browsing activity, such as determining where a consumer is navigating to, what a consumer is typing on a web page, when a consumer activates a mouse or keyboard, and the like, is, in general, known in the art and not further described here. For example, message delivery program 160 may listen for event notifications from web browser 132 as part of its monitoring function. Message delivery program 160 may protect the consumer's privacy by maintaining the consumer's anonymity (e.g., by using a machine ID to refer to the consumer) and encrypting sensitive information, such as credit card numbers.

In one embodiment, message delivery program 160 monitors web browser 132 for the uniform resource locator (URL) of websites visited by the consumer. For each website visited by the consumer, message delivery program 160 may send message server 163 a data packet that includes the unique identification (ID) number of the consumer, the machine ID number of client computer 130, the local time stamp, and the URL of the visited website.

Message server 163 may comprise one or more server computers in communication with message delivery program 160. Message server 163 may include a database 171 for keeping track of consumer browsing activities and website categories. Data obtained by message server 163 from message delivery program 160 may be stored in database 171. Database 171 may be a commercially available database, data file, or other means for storing and managing information.

Database 171 may contain a list of popular websites on the Internet arranged by category. For example, a team of human researchers may assign one or more categories for popular websites. Thus, a website for a car manufacturer may be categorized under “car manufacturers,” a travel-related website may be categorized under “travel, vacation,” a website for a hotel may be categorized under “hotel,” and so on. Table 1 shows example entries in a database 171, listing various websites and their respective categories.

TABLE 1

| DOMAIN | CATEGORY |
|---|---|
| travelcities.com | Travel |
| Experentia.com | travel, hotel, vacation |
| tourtheplanet.com | travel, hotel, vacation |
| bilton.com | hotel, entertainment, vacation |
| baviz.com | car rental, travel |
| hartz.com | car rental, travel |
| dodgy.com | car manufacturer |
| chev.com | car manufacturer |
| fordham.com | car manufacturer |
| etc. | |

In the example of Table 1, a website having the domain name “travelcities.com” is under the category travel, while a website having the domain name hartz.com is under the categories car rental and travel. Thus, querying the database for the categories of travelcities.com would yield travel. Similarly, a query for the categories of hartz.com would yield car rental and travel. Of course, the database may also be queried to find all websites under the category travel, and so on. Note that categorization of websites visited by the consumer may also be performed by message delivery program 160 or another client program in client computer 130. In that case, message delivery program 160 may provide the categories, in addition to or instead of the addresses, of websites visited by the consumer.

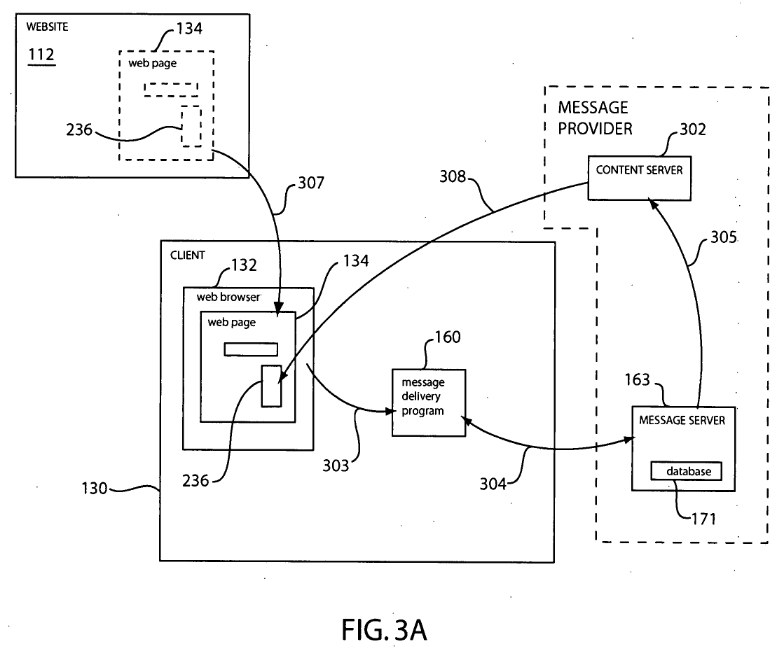

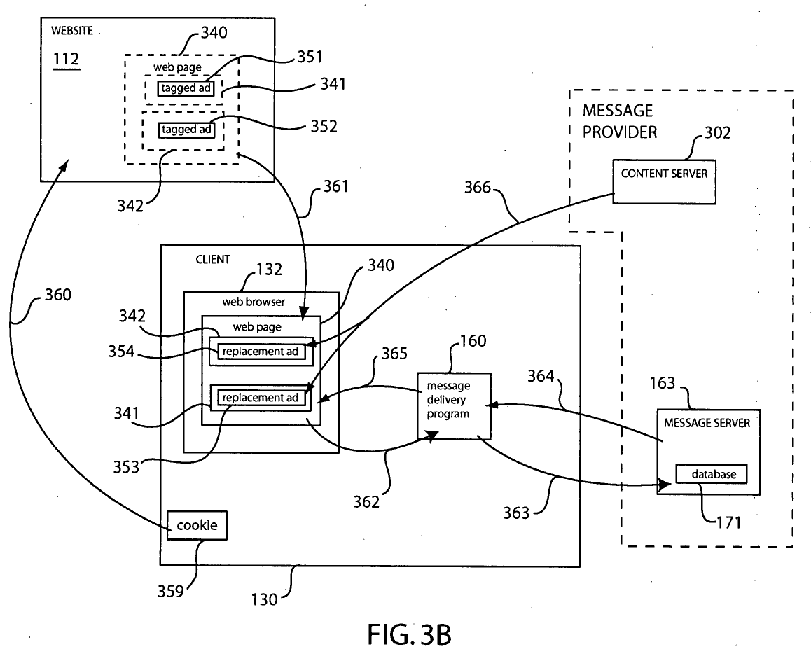

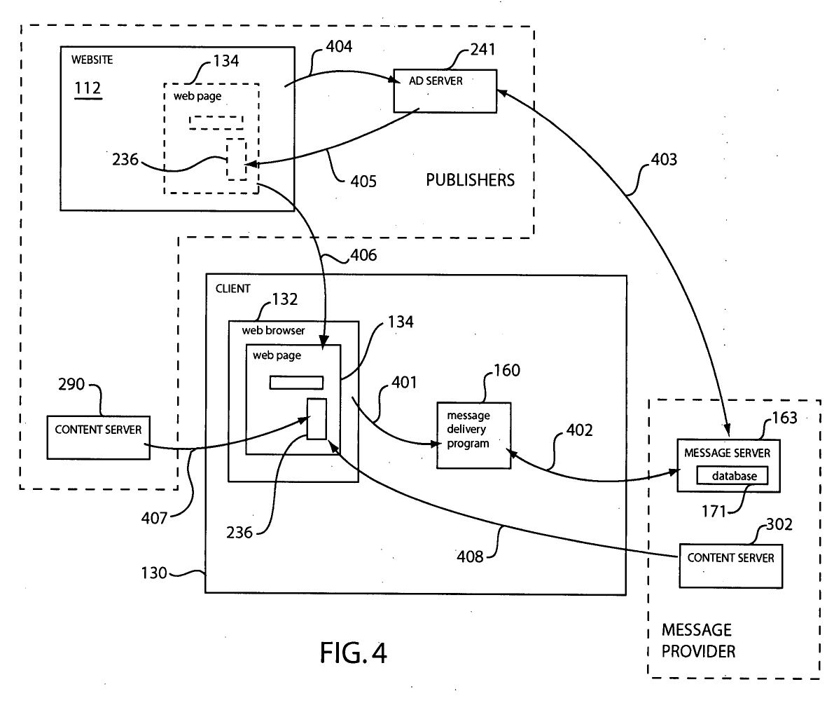

Database 171 may include a listing of all advertisements available in an associated content server, such as a content server 164 and a content server 302 (shown in FIGS. 3A, 3B, and 4). The available advertisements may be arranged by category. For example, database 171 may include a listing of all available advertisements in the associated content server under the category travel, car manufacturer, and so on. This advantageously allows relevant advertisements to be provided to a consumer depending on categories she is most likely interested in based on her behavioral information or the web page she is currently viewing.

Database 171 may also include a listing of all websites visited by consumers, including time stamps indicating when a particular website was visited. Thus, database 171 may be queried for all websites visited by a consumer (as identified by a unique ID of the consumer or machine ID of the client computer) by domain name, category, frequency, and so on. For example, if the consumer visited hartz.com two times the last three days, a query for categories of websites visited by the consumer more than once the last five days would include the category “car rental.” Table 2 shows example entries in database 171, listing the websites visited by consumers (identified by machine ID) at a particular date and time. In the example of Table 2, the consumer on a client computer 130 with machine ID “34571893097” has visited the minivans webpage of hartz.com at 10:23 AM on Jul. 8, 2003, the main page of bookstore.com at 10:13 PM on Jul. 9, 2003, the main page of hartz.com (again) at 11:30 PM on Jul. 9, 2003, and so on.

TABLE 2

| Machine ID | Visited Domains |
|---|---|
| 34571893097 | (hartz.com/minivans, 10:23:00, |
| | 07082003), (bookstore.com, |
| | 22:13:17, 07092003), (hartz.com, |
| | 23:30:06, 07092003). . . |
| 25663671234 | (bahoo.com/books/suspense, |
| | 11:33:10, 07082003), |
| | (restaurant.com, 21:13:16, |
| | 07092003), . . . |
| 54211243280 | (baviz.com/suvs, 10:23:02, |
| | 07072003), (comics.com, |
| | 20:16:19, 07082003), . . . |
| etc. | |

A consumer's behavioral information, which may include the consumer's browsing activities, may be advantageously employed to select a relevant advertisement for the consumer. For example, if the consumer has been visiting car rental websites the last couple of days, an advertisement for a car rental would be more relevant to the consumer than an advertisement for home mortgages. Message server 163 may pass that information to message delivery program 160 in the form of a URL pointed to content server 164. Message delivery program 160 may then post that URL in presentation vehicle 162 as an advertisement 166, such that a car rental advertisement at the URL is pulled from content server 164 and displayed on the presentation vehicle.

Other behavioral information that may be monitored by message delivery program 160 for reporting to and use by message server 163 includes the advertisements presented on a presentation vehicle 162, the number and types of advertisements the consumer clicked-through (i.e., responded to), and so on.

A client-side program, such as message delivery program 160, allows for web-wide monitoring of consumer browsing activities. Unlike a website, which can only monitor consumer behavior on the website or related websites, message delivery program 160 can advantageously collect behavioral information across multiple, un-related websites. Consumer behavioral information obtained by message delivery program 160 thus allows for selection of targeted, relevant advertisements.

In accordance with an embodiment of the present invention, a client-side program (i.e., a computer program residing and operating in a client computer) is employed to obtain consumer behavioral information. The behavioral information may be employed in the selection of advertisements to be posted on web pages of online publishers. In the example of FIG. 1, a message provider or group of message providers providing message delivery program 160 and operating message server 163 and content server 164 may form a partnership with online publishers to allow the publishers to deliver more relevant advertisements. For example, the message provider may have a contractual agreement with the operator of website 112 to help website 112 select advertisements for posting on web page 134. The message provider may receive payment from the operator of website 112 for this service. Alternatively, the message provider may post its own advertisements on a web page 134 received from website 112. The message provider may pay the operator of website 112 for each advertisement posted this way.

An example processing flow in accordance with an embodiment of the present invention is now described with reference to FIG. 1. A consumer on client computer 130 may employ web browser 132 to receive a web page 134 from website 112, 113, or 115 (arrow 101, 102, or 103). Message delivery program 160 detects this navigation (arrow 104) and so informs message server 163 (arrow 105). Message server 163 adds the navigation information to its database 171 and selects an advertisement for display on presentation vehicle 162. The advertisement may be selected using consumer behavioral information. The advertisement may be stored at a location in content server 164 and identified by a URL, arbitrarily referred to as a “first URL.” Message server 163 may pass the first URL to message delivery program 160 (arrow 105), which may then display presentation vehicle 162 (arrow 106) with the first URL. This allows the advertisement to be pulled from content server 164 (arrow 107) and be displayed on presentation vehicle 162 as advertisement 166.

Message server 163 may also select another advertisement for posting on web page 132 as advertisement 136. The advertisement may also be based on consumer behavioral information. The advertisement may have a URL, which is arbitrarily referred to as a “second URL.” The advertisement having the second URL may be stored in a content server 190, which may be operated by an online publisher, the message provider, or their partners. Inserting the second URL in web page 132 allows the advertisement to be pulled from content server 190 (arrow 108) for posting as advertisement 136.

As can be appreciated, advertisements 166 and 136 are more likely to be of relevance to the consumer because they are based on consumer behavioral information. This is in contrast to conventional techniques for selecting advertisements, which are solely based on rotation or consumer-supplied demographics information that may be inaccurate or incomplete.

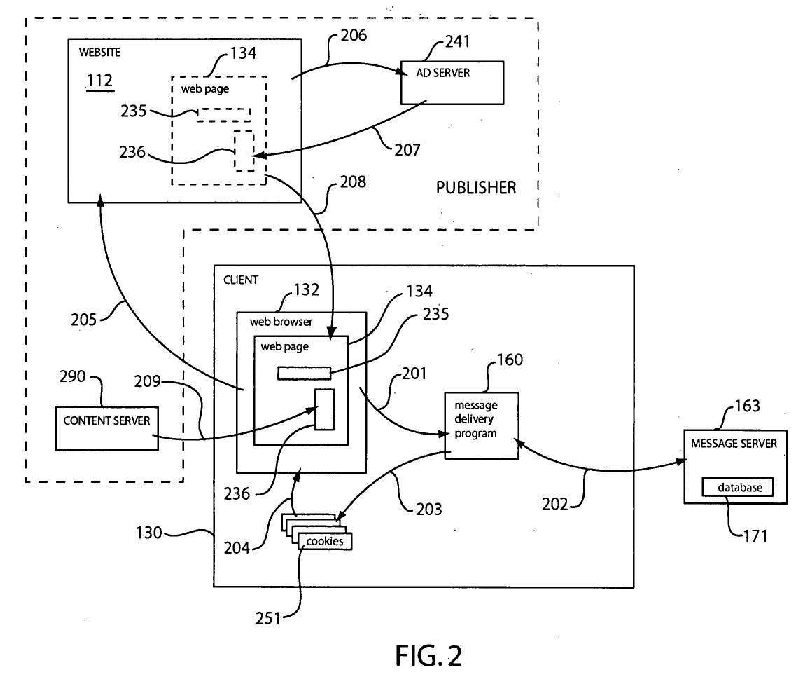

FIG. 2 schematically illustrates a technique for posting messages on documents in accordance with an embodiment of the present invention. In the example of FIG. 2, advertising-related information is stored by message delivery program 160 in one or more cookies 251. The advertising-related information stored in a cookie 251 may comprise behavioral information obtained by message delivery program 160 and stored in message server 163. For example, the categories of websites visited by the consumer may be stored in a cookie 251 designated for website 112. As a specific example, if the consumer has been visiting websites relating to hotels and car manufacturers, the cookie 251 may have an entry that indicates “hotels” and “car manufacturers” (or codes for the aforementioned categories). This allows website 112 to read the cookie 251 and use its contents in selecting the most relevant advertisement available in its inventory (i.e., available advertisements for display). In the just mentioned example, website 112 preferably selects an advertisement relating to hotels, car manufacturers, or both for posting on web page 134.

An example processing flow in accordance with an embodiment of the present invention is now described with reference to FIG. 2. In the example of FIG. 2, message delivery program 160 monitors (arrow 201) the browsing activities of the consumer for reporting to message server 163 (arrow 202). The categories of websites visited by the consumer over a period of time are then reported back by message server 163 to message delivery program 160 (arrow 202). Message delivery program 160 updates the cookie 251 (arrow 203) of website 112 to indicate the categories. Message delivery program 160 may update the cookie 251 by requesting web browser 132 to do so or by directly modifying the cookie.

It is to be noted that in lieu of sending back categories of websites, message server 163 may simply return the domain names of websites visited by the consumer. Those domain names may be included in the cookie 251 to help website 112 select relevant advertisements. The amount of behavioral information returned by message server 163 may also be configured or filtered to meet the needs of specific applications. For example, website 112 may only be interested to know those websites visited by the consumer within the last five days, those that the consumer visited at least two times, and so on.

Browser 132 may read the cookie 251 (arrow 204) of website 112, and pass the cookie 251 to website 112 (arrow 205) when the consumer navigates to website 112 to view web page 134. Web page 134 may have slots 235 and 236 where advertisements may be posted. Computer-readable program code in web page 134 may pull an advertisement from a content server for posting in a slot. In the example of FIG. 2, website 112 passes the contents of the cookie 251 to an advertising server 241 (arrow 206), which uses the advertising-related information in the cookie to select a relevant advertisement for the consumer. The URL of the selected advertisement, arbitrarily referred to as a “third URL,” is then inserted in a slot in web page 134. The third URL is inserted in slot 236 (arrow 207) in this example. The third URL is the address of an advertisement stored in a content server 290. Thus, when web page 134 is provided to client computer 130 (arrow 208), the advertisement having the third URL is pulled from content server 290 (arrow 209) and displayed in slot 236 of web page 134.

An advertising server 241 may comprise one or more server computers for posting advertisements on web pages. An advertising server may include a database containing a list of available advertisements and their properties, computer-readable program code for querying the database and selecting advertisements, and the advertisements themselves. In the example of FIG. 2, the advertisements are denoted as being stored in a separate content server 290. It should be understood, however, that content server 290 may also be a part of advertising server 241.

In the example of FIG. 2, advertising server 241 and content server 290 are described as being operated by an online publisher or an entity in partnership with an online publisher. This is to illustrate that currently operating websites may take advantage of embodiments of the present invention by simply contracting with a message provider to receive advertising-related information. Other than adapting website 112 to read and make use of the contents of a cookie 251, website 112 does not require extensive modifications or client-presence to make use of embodiments of the present invention. A message provider that distributes message delivery programs 160 to client computers on the Internet may thus provide an advertisement-selection service to currently operating websites.

FIG. 3A schematically illustrates a technique for posting messages on documents in accordance with an embodiment of the present invention. In the example of FIG. 3A, the message provider itself, not an online publisher, selects and posts the advertisement to be displayed on the web page. The message provider may do so by purchasing advertising slots from the inventory of an online publisher. The message provider that operates message server 163, operates content server 302, and provided message delivery program 160 to the consumer may purchase advertising slots in particular web pages of website 112. For example, the message provider may pay the operator of website 112 for the right to display an advertisement in slot 236 of web page 134. The advertisement to be displayed in slot 236 may have a URL, arbitrarily referred to as a “fourth URL.” The message provider may provide the fourth URL to the operator of website 112. Website 112 then inserts the fourth URL in slot 236 to allow the advertisement to be pulled from content server 302 when web page 134 is received in client computer 130.

An example processing flow in accordance with an embodiment of the present invention is now described with reference to FIG. 3A. In the example of FIG. 3A, message delivery program 160 detects (arrow 303) that web browser 132 is being pointed to website 112. Message delivery program 160 so informs message server 163 (arrow 304), which then selects a relevant advertisement based on the consumer's behavioral information. Message server 163 instructs content server 302 (arrow 305) to assign the fourth URL to the selected advertisement.

Upon request from web browser 132, web page 134 is provided to client computer 130 (arrow 307). Website 112 inserted the fourth URL in slot 236 per a contractual agreement with the message provider. Thus, when web page 134 arrives in client computer 130, the selected advertisement with the fourth URL is pulled from content server 302 (arrow 308) and displayed in slot 236 of web page 134.

FIG. 3B schematically illustrates a technique for posting messages on documents in accordance with an embodiment of the present invention. The technique of FIG. 3B is similar to that of FIG. 3A in that the message provider places the advertisements on the web page 340. In FIG. 3B, website 112 places tags on selected advertisements posted on the web page 340. The tags advantageously allow website 112 to identify advertisements that may be replaced. The tagged advertisements may be those that are not paid for (e.g., the website's own advertisements), those sold at a discount, or other low-priority advertisements. In the example shown in FIG. 3B, advertising slots 341 and 342 on the web page 340 contain tagged advertisements 351 and 352, respectively. A tag may be predefined, unique text or code accompanying the advertisements on the web page. A tag may be part of the HTML code for pulling the advertisement into the client computer, for example. A tag may include information as to the size of the advertisement. Message delivery program 160 may detect the tags on the web page after the web page fully loads in the client computer. Message delivery program 160 may then replace the tagged advertisements with other advertisements.

A website may tag selected advertisements without regard as to whether the message provider (e.g., by way of a message delivery program) has replacement advertisements in its inventory. A Website may also tag advertisements depending on information from the message provider. Such information may be communicated to the website using a cookie, for example. When the message provider has available replacement advertisements, its message delivery program may so update the website's cookie in the client computer. This allows the website to read the cookie upon receiving a request for a web page from the client computer, to tag replaceable advertisements on the web page, and then provide the web page to the client computer.

An example processing flow in accordance with an embodiment of the present invention is now described with reference to FIG. 3B. In the example of FIG. 3B, a cookie 359 may be updated by message delivery program 160 to inform website 112 that the message provider has available replacement advertisements. Message delivery program 160 may update the contents of cookie 359 by requesting web browser 132 to do so or by directly writing on the cookie. When client computer 130 requests web page 340 from website 112, website 112 may read cookie 359 prior to providing the web page (arrow 360). Depending on the contents of cookie 359, website 112 may tag selected advertisements on web page 340. In the example shown in FIG. 3B, advertisements 351 and 352 in slots 341 and 342, respectively, have been tagged by website 112. Note that the tagging of advertisements based on information from the message provider is not necessary. As mentioned above, website 112 may simply tag all replaceable advertisements without instructions from the message provider.

Still referring to FIG. 3B, website 112 may provide its web page 340 to client computer 130 (arrow 361). Web browser 132 receives the web page 340, which initially may include tagged advertisements 351 and 352. Message delivery program 160 detects the tagged advertisements (arrow 362) and so informs message server 163 (arrow 363). Message server 163 may search database 171 for the most relevant replacement advertisements available in content server 302. The replacement advertisements may be selected based on behavioral information and the size of the slots containing the tagged advertisements. The size of the slots may be based on an industry or agreed-upon standard and indicated on the tagged advertisements or elsewhere in the web page. The replacement advertisements may also be selected based on the contents of the tagged advertisements. For example, a replacement advertisement may be anything that is different from a tagged advertisement. This may occur in situations where message delivery program 160 detects that the tagged advertisement has already been seen multiple times by the consumer, or is an irrelevant advertisement because the consumer already has the advertised product (for example, an advertisement for a utility program that message delivery program 160 detects is already in the client computer).

Message server 163 may inform message delivery program 160 of the most relevant advertisements available in content server 302 (arrow 364). The information provided by message server 163 may include the URLs of the relevant advertisements, which are replacement advertisements 353 and 354 in the example of FIG. 3B. Message delivery program 160 may then insert the URLs of replacement advertisements 353 and 354 in slots 341 and 342, respectively (arrow 365). This results in replacement advertisements 353 and 354 being pulled from content server 302 (arrow 366) and replacing tagged advertisements 351 and 352 on web page 340.

There are several reasons why a message provider would want to display its advertisements in web pages of online publishers rather than in its own presentation vehicles (e.g., see presentation vehicle 162 shown in FIG. 1). For one, the number of advertisements that can be displayed in a presentation vehicle for any given period of time may be limited to avoid aggravating the consumer with too many advertisements. Although the advertisement displayed in web page 134 is still, technically speaking, from the message provider, the consumer will associate that advertisement with website 112. And since website 112 may be providing other free services to the consumer, such as free e-mail, for example, the consumer is less likely to be annoyed with the advertisement on web page 134.

Another reason why a message provider would want to display its advertisements in web pages of online publishers has to do with advertising cost and inventory size. Depending on the market for advertisements, some online publishers may be willing to sell unsold advertisement slots at low cost. A message provider may purchase these advertisement slots at a discount to increase the message provider's own inventory and to gain more options on where to place advertisements.

Furthermore, some message providers advertise their products (e.g., utility program 167 shown in FIG. 1 or other goods and services) in popular websites. For consumers who already have the message provider's products, advertisements for those products are a waste of advertising dollars. In that case, it is advantageous for the message provider to detect their advertisement on the web page and replace that advertisement with another.

FIG. 4 schematically illustrates a technique for posting messages on documents in accordance with an embodiment of the present invention. In the example of FIG. 4, the message provider works with an online publisher in selecting advertisements to be posted on a web page 134. One way of implementing this feature is to have a communications link between an advertising server associated with the publisher and a message server associated with the message provider. The message server may pass consumer behavioral information to the advertising server, which then uses the behavioral information to select an advertisement. The message provider may charge the online publisher for its services.

An example processing flow in accordance with an embodiment of the present invention is now described with reference to FIG. 4. In the example of FIG. 4, message delivery program 160 detects (arrow 401) that web browser 132 is being pointed to a web page of website 112. Message delivery program 160 so informs message server 163 (arrow 402), which then passes the consumer's behavioral information and the machine ID of client computer 130 to advertising server 241.(arrow 403). A cookie (not shown) of website 112 stored in client computer 130 may indicate this machine ID to allow advertising server 241 to match the behavioral information received from message server 163 with the web page 134 to be provided to the consumer. Prior to providing a web page 134 to client computer 130, website 112 may request advertising server 241 to populate the web page 134 that will be provided to client computer 130 (identified by machine ID) with URLs of advertisements (arrow 404). Advertising server 241 proceeds to populate slot 236 (arrow 405) of the web page 134 with a URL, arbitrarily referred to as a “fifth URL,” of an advertisement selected based on behavioral information received from message server 163. When web page 134 is received in client.computer 130 (arrow 406), the advertisement having the fifth URL is pulled from content server 290 (arrow 407) and posted on web page 134.

Techniques for posting messages on documents delivered over a computer network have been disclosed. While specific embodiments have been provided, it is to be understood that these embodiments are for illustration purposes and not limiting. Many additional embodiments will be apparent to persons of ordinary skill in the art reading this disclosure.

1. A method of posting messages on documents delivered over a computer network, the method comprising:
monitoring browsing activities of a consumer across a plurality of websites to obtain a behavioral information; and
using the behavioral information to select an advertisement to be posted on a web page of a website provided to a client computer operated by the consumer.

2. The method of claim 1 wherein monitoring the browsing activities of the consumer is performed by a client-side program stored and running in the client computer.

3. The method of claim 1 wherein each of the plurality of websites comprises a server computer accessible over an Internet.

4. The method of claim 1 wherein the behavioral information includes a listing of categories of websites visited by the consumer.

5. The method of claim 1 wherein the behavioral information includes a listing of websites visited by the consumer.

6. The method of claim 1 wherein the advertisement is posted by a server associated with a website providing the web page.

7. The method of claim 2 wherein the advertisement is posted by a server associated with a message provider that provided the client-side program to the consumer.

8. The method of claim 1 further comprising:
storing the behavioral information in a file in the client computer; and
providing the file to a website providing the web page.

9. The method of claim 8 wherein the file comprises a cookie.

10. The method of claim 1 wherein the behavioral information is provided to an advertising server.

11. The method of claim 1 wherein the advertisement replaces another advertisement on the web page.

12. The method of claim 11 wherein the advertisement replaces an advertisement on the web page identified as being replaceable at the client computer.

13. The method of claim 12 wherein the replaceable advertisement has a tag.

14. A method of posting messages on documents delivered over a computer network, the method comprising:
providing a web page to a client computer, the web page including an advertisement selected based on information obtained by monitoring a navigation of the client computer across a plurality of unrelated websites on an Internet.

15. The method of claim 14 wherein the web page is from a website not among the plurality of websites.

16. The method of claim 14 wherein the behavioral information is stored in a cookie read by a website that provided the web page.

17. The method of claim 14 wherein the advertisement is posted by a server associated with a website that provided the web page.

18. The method of claim 14 wherein the behavioral information is obtained by a client-side program stored and running in the client computer.

19. The method of claim 14 wherein the advertisement replaces another advertisement on the web page specifically identified as being replaceable at the client computer.

20. The method of claim 14 wherein the advertisement replaces another advertisement on the web page.

21. A computer system comprising:
a client computer with a web browser and a client-side program, the client-side program being configured to monitor navigation of the web browser across several websites to obtain information about a consumer employing the client computer; and
a website with a web page, the website being configured to provide the web page to the client computer over a computer network, the web page having an advertisement selected based on the information about the consumer.

22. The system of claim 21 wherein the information is provided to the website via a cookie.

23. The system of claim 21 wherein the advertisement is posted by a server computer associated with an entity that provided the client-side program to the client computer.

24. The system of claim 21 wherein the advertisement is posted by a server computer associated with the website.

25. The system of claim 21 wherein the information obtained by the client-side program is provided to a message server computer.
